(19) United States
(12) Patent Application Publication
(10) Pub. No.: US 2018/0184438 A1
(43) Pub. Date: Jun. 28, 2018

(54) PERSISTENT SCHEDULING AND FORWARDING WHILE RECEIVING IN WIRELESS TIME SENSITIVE NETWORKS

(71) Applicant: Intel Corporation, Santa Clara, CA (US)

(72) Inventors: Dave Cavalcanti, Portland, OR (US); Shahrnaz Azizi, Culptertino, CA (US); Alexander Min, Portland, OR (US); Robert Stacey, Portland, OR (US)

(21) Appl. No.: 15/392,798

(22) Filed: Dec. 28, 2016

(51) Int. Cl. H04W 72/12; H04W 56/00

(52) U.S. Cl. CPC H04W 72/12; H04W 56/0005

(57) ABSTRACT

This disclosure describes systems, methods, and apparatus related to wireless time sensitive networking (TSN). A device may determine a beacon frame. The device may cause to send the beacon frame to a second device and a third device. The device may cause to send first scheduling information to allocate a slot for receiving a first transmission from the second device. The device may determine a service period for additional slots for receiving a second transmission from the third device. The device may cause to send second scheduling information to allocate the additional slots. A device may receive a data frame including routing information for frame forwarding. The device may decode the routing information for a first preamble. The device may determine that the first preamble matches a second preamble. The device may cause to send the routing information to a second device while receiving the data frame.

### TECHNICAL FIELD

This disclosure generally relates to systems, methods, and devices for wireless communications and, more particularly, persistent scheduling and forwarding while receiving in wireless time sensitive networks.

### BACKGROUND

Time sensitive networking (TSN) includes networks that provide time synchronization and timeliness, with focus on deterministic latency and reliability/redundancy to critical data flows. Traditionally, TSN applications have been using wired connectivity. However, wiring has several limitations, such as, high maintenance cost, weight, or limited mobility.

### BRIEF DESCRIPTION OF THE DRAWINGS

FIG. 1 depicts a diagram illustrating an example network environment for an illustrative wireless TSN (WTSN) system, in accordance with one or more example embodiments of the present disclosure.

FIG. 2 depicts an illustrative timing diagram of a scheduled TSN data flow, in accordance with one or more example embodiments of the present disclosure.

FIG. 3A depicts an illustrative timing diagram of a scheduled TSN data flow, in accordance with one or more example embodiments of the present disclosure.

FIG. 3B depicts an illustrative timing diagram of a scheduled TSN data flow, in accordance with one or more example embodiments of the present disclosure.

FIG. 4A depicts an illustrative timing diagram of a scheduled data flow for TSN and non-TSN data, in accordance with one or more example embodiments of the present disclosure.

FIG. 4B depicts an illustrative timing diagram of a scheduled data flow for TSN and non-TSN data, in accordance with one or more example embodiments of the present disclosure.

FIG. 5A depicts a flow diagram of an illustrative process for an illustrative persistent scheduling WTSN system, in accordance with one or more example embodiments of the present disclosure.

FIG. 5B depicts a flow diagram of an illustrative process for an illustrative persistent scheduling WTSN system, in accordance with one or more example embodiments of the present disclosure.

FIG. 6 depicts a diagram illustrating WTSN system for performing a forwarding while receiving (FWR) data frame flow, in accordance with one or more example embodiments of the present disclosure.

FIG. 7A depicts a diagram illustrating WTSN system for performing a forwarding while receiving (FWR) data frame flow, in accordance with one or more example embodiments of the present disclosure.

FIG. 7B depicts a diagram illustrating WTSN system for performing a forwarding while receiving (FWR) data frame flow, in accordance with one or more example embodiments of the present disclosure.

FIG. 7C depicts a diagram illustrating WTSN system for performing a forwarding while receiving (FWR) data frame flow, in accordance with one or more example embodiments of the present disclosure.

FIG. 7D depicts a diagram illustrating WTSN system for performing a forwarding while receiving (FWR) data frame flow, in accordance with one or more example embodiments of the present disclosure. FIG. 8 depicts a diagram illustrating a forwarding while receiving (FWR) data frame flow in an illustrative WTSN system, in accordance with one or more example embodiments of the present disclosure.

FIG. 9 depicts a diagram illustrating a WTSN system for performing an FWR data frame flow, in accordance with one or more example embodiments of the present disclosure.

FIG. 10 depicts a flow diagram of an illustrative process for an illustrative FWR WTSN system, in accordance with one or more example embodiments of the present disclosure.

FIG. 11 illustrates a functional diagram of an example communication station that may be suitable for use as a user device, in accordance with one or more example embodiments of the present disclosure.

FIG. 12 illustrates a block diagram of an example machine upon which any of one or more techniques (e.g., methods) may be performed, in accordance with one or more example embodiments of the present disclosure.

### DETAILED DESCRIPTION

Example embodiments described herein provide certain systems, methods, and devices, for providing messaging to wireless devices in various wireless networks, including but not limited to Wi-Fi, TSN, Wireless USB, Wi-Fi peer-to-peer (P2P), Bluetooth, NFC, or any other communication standard.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some communications require reliable and deterministic communications between devices. One example may be what is known as TSN. TSN applications require very low and bounded transmission latency and high availability. TSN applications include a mix of traffic patterns and requirements from synchronous data flows (e.g., from sensors to a controller in a closed loop control system), to asynchronous events (e.g., a sensor detecting an anomaly in a monitored process and sending a report right away), to video streaming for remote asset monitoring and background IT/office traffic. Many TSN applications also require communication between devices across multiple links/hops (e.g., in a mesh topology) with ultra-low latency on the order of 10's of microseconds.

A wireless solution for TSN applications may include Wi-Fi as a potential candidate to enable wireless TSN applications. A benefit of Wi-Fi as a medium for wireless TSN applications is that Wi-Fi communications are carried out in unlicensed spectrum, with low deployment costs. However, the unlicensed spectrum also imposes challenges, especially to guarantee reliabilities and latencies comparable to wired protocols (e.g., Ethernet TSN).

Example embodiments of the present disclosure relate to systems, methods, and devices for persistent scheduling and forwarding while receiving for time sensitive applications in wireless networks. It should be understood that persistent scheduling may occur in a network in which synchronous transmission occurs between one or more wireless TSN devices (e.g., a safety unit) and an access point (AP). The AP may define a service period that defines (i) a periodic start of persistent transmission points and (ii) a duration of contention-free access. continuing to exist or endure over a prolonged period.

In one embodiment, a WTSN system may enable synchronous TSN data flows where a TSN station has a fixed packet inter-arrival period and packet size. These data flows may require a minimum and maximum latency with corresponding values being determined by a control loop cycle.

In one embodiment, a WTSN system may define a protocol for scheduling synchronous data exchange within the existing contention based frame work of the 802.11 WLAN standard specifications.

In one embodiment, a WTSN system may enable persistent scheduling for the transmission of wireless time sensitive devices in industrial automation scenarios. The WTSN system may enable an AP to define frequency multiplexed service periods in which WTSN devices may transmit synchronous short data packets in pre-scheduled time/frequency slots.

By enabling the synchronous transmission of short packet sizes with a fixed packet inter-arrival period, minimum and maximum latency requirements for WTSN devices may be met.

In one embodiment, a WTSN system may define protocols to initiate transmission (forwarding) of a data frame before the data frame is completely received and without involvement of routing layers.

In one embodiment, a WTSN system may enable a relay node to identify frames of a data flow using a given multi-hop route that needs to be forwarded and initiate early forwarding (while receiving). The WTSN system may define a mapping between routes (at the network layer) and forwarding infraction at the physical (PHY)/media access control (MAC) layers per data flow/route and further determine when to use a fast forwarding capability depending on the link. The fast forwarding capability may be used with a reservation-based or a contention-based MAC layer. When used with a contention-based MAC layer, the fast forwarding capability may enable early channel contention at relay nodes, thereby helping to reduce channel access delay.

In one embodiment, a WTSN system may introduce forwarding information in one or more delimiter fields in an aggregate media access protocol data unit (MPDU) transmissions or add a physical layer (PHY) preamble or additional field in a PHY header of a data frame.

The aforementioned forwarding information and fast forwarding capability may enable faster source routing capability which may significantly reduce end-to-end latency associated with WTSN devices (especially as the number of hops between source and destination increases).

The above descriptions are for purposes of illustration and are not meant to be limiting. Numerous other examples, configurations, processes, etc., may exist, some of which are described in detail below. Example embodiments will now be described with reference to the accompanying figures.

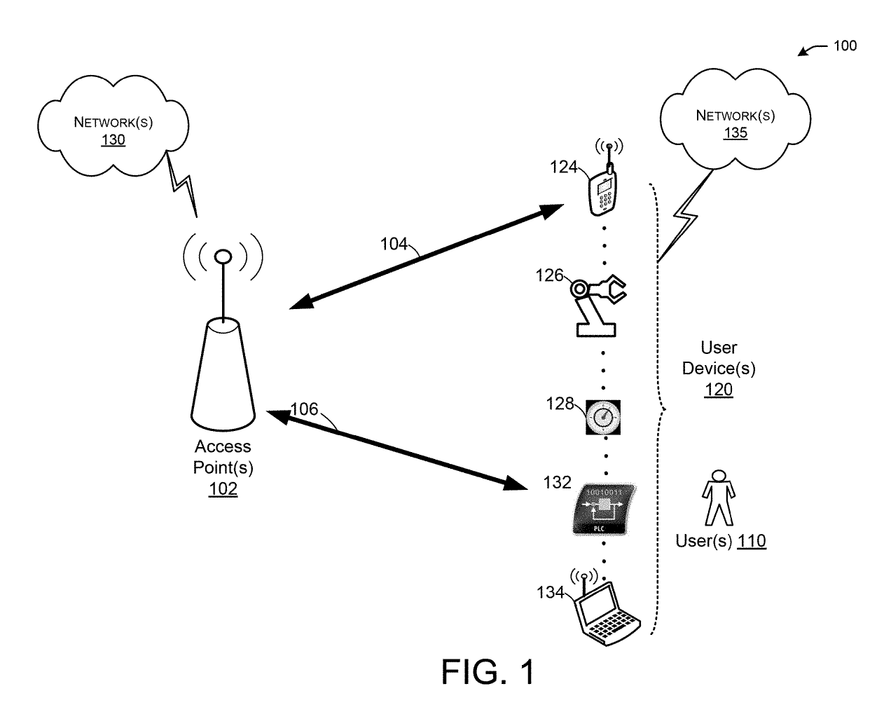

FIG. 1 is a diagram illustrating an example network environment, in accordance with one or more example embodiments of the present disclosure. Wireless network 100 may include one or more user devices 120 and one or more access point(s) (AP) 102, which may communicate in accordance with and compliant with various communication standards and protocols, such as, Wi-Fi, TSN, Wireless USB, P2P, Bluetooth, NFC, or any other communication standard. The user device(s) 120 may be mobile devices that are non-stationary (e.g., not having fixed locations) or may be stationary devices.

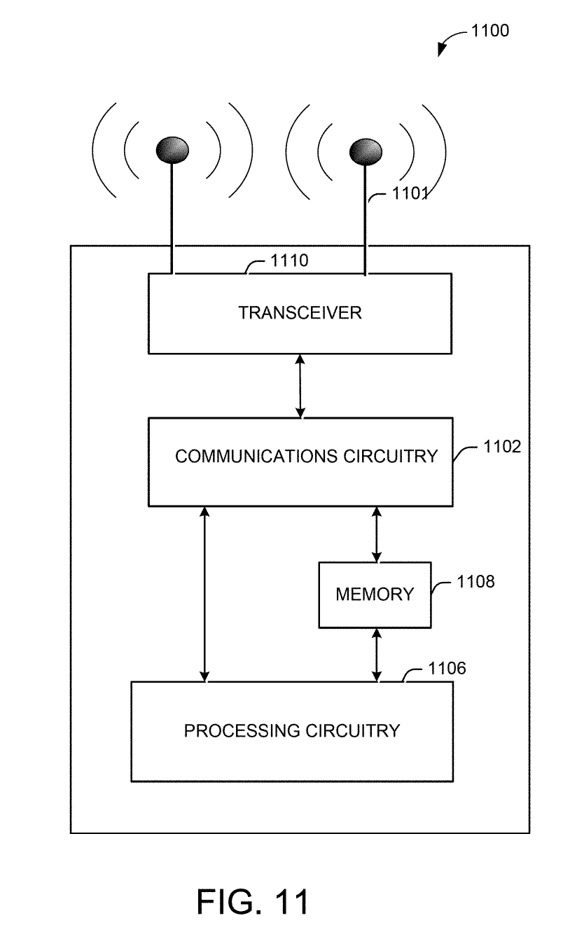

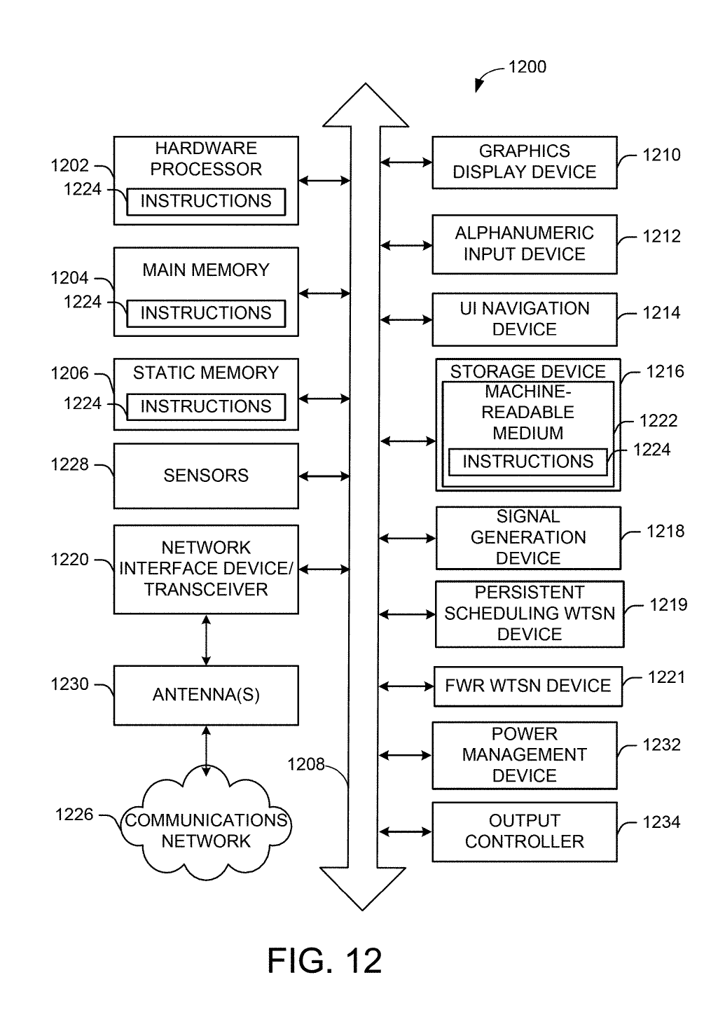

In some embodiments, the user devices 120 and AP 102 may include one or more computer systems similar to that of the functional diagram of FIG. 11 and/or the example machine/system of FIG. 12.

One or more illustrative user device(s) 120 and/or AP 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP 102 may operate as a personal basic service set (PBSS) control point/access point (PCP/AP). The user device(s) 120 (e.g., 124, 126, or 128) and/or AP 102 may include any suitable processor-driven device including, but not limited to, a mobile device or a non-mobile, e.g., a static, device. For example, user device(s) 120 and/or AP 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a robotic device, an actuator, a robotic arm, an industrial robotic device, a programmable logic controller (PLC), a safety controller and monitoring device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

Any of the user device(s) 120 (e.g., user devices 124, 126, 128, 132, and 134), and AP 102 may be configured to communicate with each other via one or more communications networks 130 and/or 135 wirelessly or wired. The user device(s) 120 may also communicate peer-to-peer or directly with each other with or without the AP 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128, 132, and 134) and AP 102 may include one or more communications antennas. The one or more communications antennas may be any suitable type of antennas corresponding to the communications protocols used by the user device(s) 120 (e.g., user devices 124, 126, 128, 132, and 134), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP 102.

Any of the user device(s) 120 (e.g., user devices 124, 126, 128, 132, and 134), and AP 102 may be configured to perform directional transmission and/or directional reception in conjunction with wirelessly communicating in a wireless network. Any of the user device(s) 120 (e.g., user devices 124, 126, 128, 132, and 134), and AP 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP 102 may be configured to perform any given directional transmission towards one or more defined transmit sectors. Any of the user device(s) 120 (e.g., user devices 124, 126, 128, 132, and 134), and AP 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP 102 may be configured to use all or a subset of its one or more communications antennas to perform MIMO beamforming.

Any of the user devices 120 (e.g., user devices 124, 126, 128, 132, and 134), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more communication standards and protocols, such as, Wi-Fi, TSN, Wireless USB, Wi-Fi P2P, Bluetooth, NFC, or any other communication standard. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

When an AP (e.g., AP 102) establishes communication with one or more user devices 120 (e.g., user devices 124, 126, 128, 132 and/or 134), the AP 102 may communicate in a downlink direction and the user devices 120 may communicate with the AP 102 in an uplink direction by sending frames in either direction. The user devices 120 may also communicate peer-to-peer or directly with each other with or without the AP 102. The data frames may be preceded by one or more preambles that may be part of one or more headers. These preambles may be used to allow a device (e.g., AP 102 and/or user devices 120) to detect a new incoming data frame from another device. A preamble may be a signal used in network communications to synchronize transmission timing between two or more devices (e.g., between the APs and user devices).

In one embodiment, and with reference to FIG. 1, an AP 102 may communicate with user devices 120. The user devices 120 may include one or more wireless devices (e.g., user device 124 and user device 134) and one or more wireless TSN devices (e.g., user devices 126, 128 and 132). The user devices may access a channel in accordance with MAC protocol rules or any other access rules (e.g., Wi-Fi, Bluetooth, NFC, etc.). It should be noted that reserving a dedicated TSN channel and controlling access to it may also be applicable to cellular systems/3GPP networks, such as LTE, 5G, or any other wireless networks. The wireless TSN devices may also access a channel according to the same or modified protocol rules. However, the AP 102 may dedicate certain channels (e.g., channel 106) for TSN applications that may be needed by the one or more wireless TSN devices and may allocate other channels (e.g., channel 104) for the non-TSN devices (e.g., user device 124 and user device 128). The AP 102 may also define one or more access rules associated with the dedicated channels. The channel 104 may be dedicated for TSN transmissions for TSN applications by TSN devices. For example, user device 126 may access the channel 106 for TSN transmissions. TSN transmissions may include transmissions that have very low transmission latency and high availability requirements. Further, the TSN transmissions may include synchronous TSN data flows between sensors, actuators, controllers, robots, in a closed loop control system. The TSN transmissions require reliable and deterministic communications. The channel 106 may be accessed by the user device 126 for a number of TSN message flows and is not limited to only one TSN message flow. The TSN message flows may depend on the type of application messages that are being transmitted between the AP 102 and the user device 126. It is understood that the above descriptions are for purposes of illustration and are not meant to be limiting.

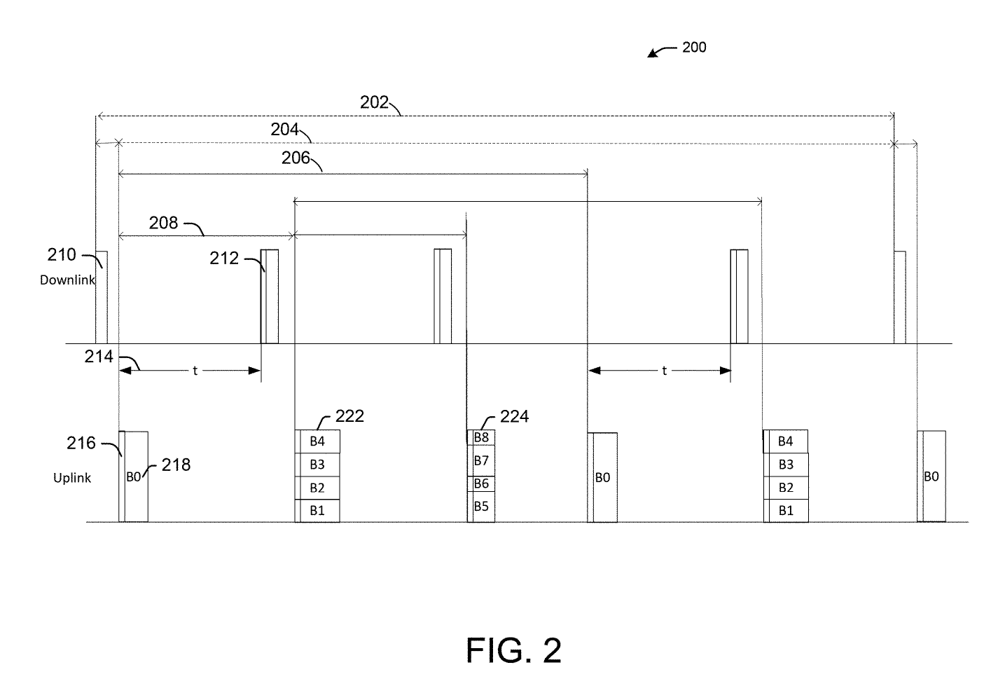

FIG. 2 depicts an illustrative timing diagram of scheduled TSN data flow 200, in accordance with one or more example embodiments of the present disclosure.

Referring to FIG. 2, there is shown uplink and downlink data frame flows where a TSN device (e.g., the device 126 of FIG. 1) may receive downlink data frames from an AP (e.g., the AP 102 of FIG. 1) and send uplink data frames to the AP. In one embodiment, the scheduled TSN data flow 200 may be utilized for persistent scheduling for synchronous transmission from a TSN device to an AP. The TSN device may be configured to send uplink data packets with an inter-arrival period (IAP) 206. In one embodiment, the IAP 206 may be a unit of time that is less than a beacon interval 202 (e.g., less than 100 ms). For example, the data packets have a short size of M bytes where M may be in the range of 50 to 700 bytes. It is understood that the aforementioned example is for purposes of illustration and not meant to be limiting.

In one embodiment, the AP may define a service period (SP) 208 that defines (i) a periodic start of persistent transmission points and (ii) a duration of contention-free allocated grants for TSN devices as shown by frames 218 (for station B0), 222 (for stations B1-B4), and 224 (for stations B5-B8). For the SP 208, periodic start times and time windows during which a TSN device (e.g., any of the stations B0-B8) transmits without contending for media (and if successful, receives back an acknowledgement (ACK)) may be granted and announced in one or more beacon frames 210 over a data transmission interval 204.

In one embodiment, the frame 218 may have a relatively large data packet to transmit periodically. Therefore, an AP (e.g., the AP 102 of FIG. 1) may reserve a wideband transmission window during time interval t 214 for the frame 218. Frames 222 and 224 may have periodic short packets to transmit. In one embodiment, the frames 222 and 224 may have different packet sizes. To reduce overhead for preamble/PHY header 216, the aforementioned short packets may be multiplexed in an orthogonal frequency division multiple access (OFDMA) structure. When using OFDMA transmission, there may not be a need for inter-frame spacing time thereby improving spectral efficiency. However, uplink transmissions in frames from different stations (STAs) may need to be synchronized to be time-synchronized for correct detection and decoding at the receiver (e.g., the AP). Furthermore, an AP may send scheduling information to allocate OFDMA sub-channels to different STAs. In order to achieve both scheduling and synchronization, an AP may transmit one or more TSN trigger frames 212.

In one embodiment, an AP may schedule a wideband transmission slot during time interval t 214 occurring after the beacon frame 210. A periodic start of and/or duration of the allocated slot may be advertised in the beacon frame 210. From the data obtained in the beacon, the station B0 218 may know it has the next slot to transmit uplink data frames. The frame 218 may synchronize to an AP using the beacon frame 210 and transmit its fixed packet size periodically with period T1 (e.g., the IAP 206) as indicated and configured by the AP.

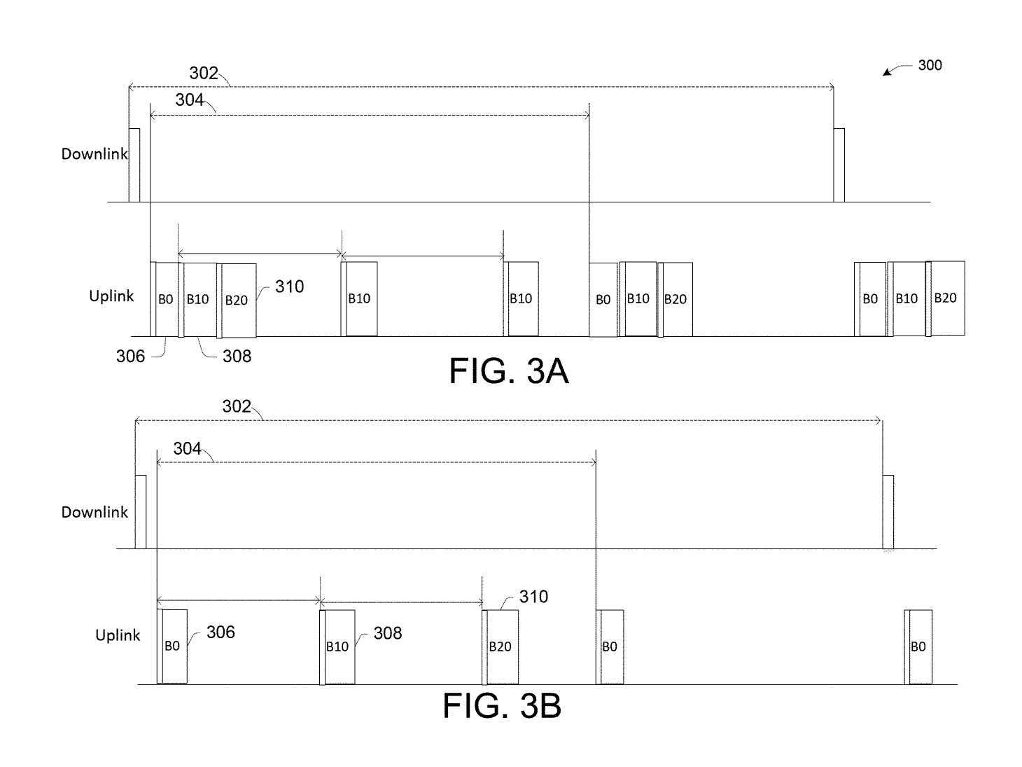

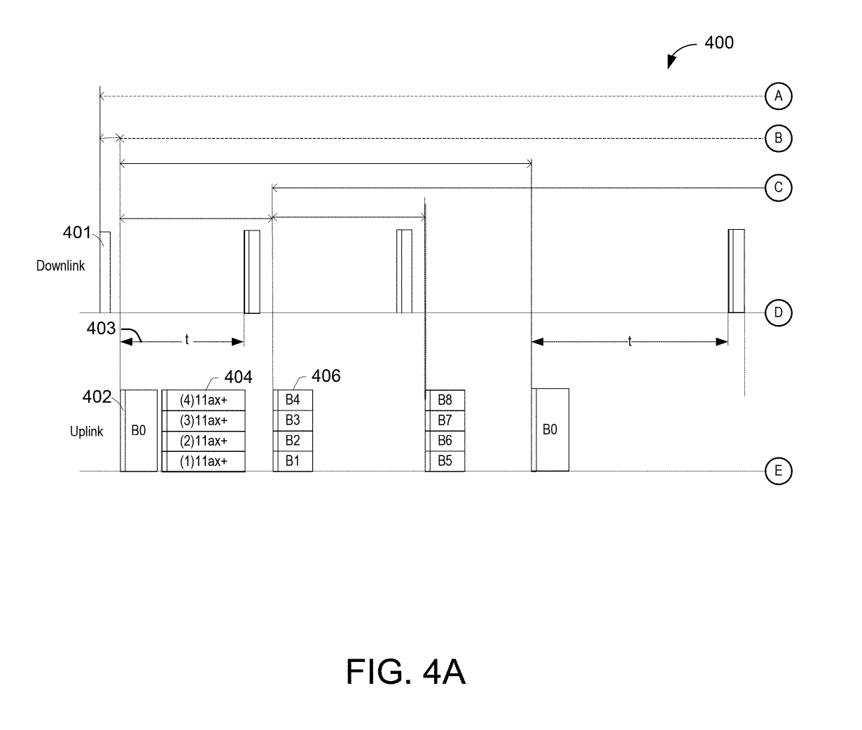

FIGS. 3A-3B depicts an illustrative timing diagram of scheduled TSN data flow 300, in accordance with one or more example embodiments of the present disclosure.

Referring to FIG. 3A, there is shown uplink and downlink data frame flows where a TSN device (e.g., the device 126 of FIG. 1) may receive downlink data frames from an AP (e.g., the AP 102 of FIG. 1) and send staggered uplink data frames to the AP (as will be described in greater detail below).

Referring to FIG. 3B, there is shown uplink and downlink data frame flows where a TSN device (e.g., the device 126 of FIG. 1) may receive downlink data frames from an AP (e.g., the AP 102 of FIG. 1) and send interlaced uplink data frames to the AP (as will be described in greater detail below).

In one embodiment, the scheduled TSN data flow 300 may be utilized for persistent scheduling for synchronous transmission from a TSN device to an AP. The TSN device may be configured to send uplink data packets with an inter-arrival period (IAP) 304. In one embodiment, the IAP 304 may be a unit of time that is less than a beacon interval 302 (e.g., less than 100 ms). For example, the data packets have a short size of M bytes where M may be in the range of 50 to 700 bytes. It is understood that the aforementioned example is for purposes of illustration and not meant to be limiting.

In one embodiment, the AP may define a service period (SP) that defines (i) a periodic start of persistent transmission points and (ii) a duration of contention-free allocated grants for TSN devices as shown by frames 306 (for station B0), 308 (for station B10), and 310 (for stations B20).

In one embodiment, the frames 306, 308 and 310 may be configured to communicate with a fixed large packet size in a WTSN system. It should be understood that in some TSN networks, there may be several stations with fixed large packet sizes. In these networks, the AP may be configured to schedule time staggered wideband transmissions so that large packets may be transmitted to meet minimum and maximum latency requirements for TSN devices. For example, an AP may be configured to schedule time staggered wideband transmissions for the frames 306, 308, and 310 sent from the stations B0, B10, and B20, respectively, as shown in FIG. 3A.

In another embodiment, the AP may be configured to interlace the scheduling of wideband transmission slots for the frames 306, 308, and 310 sent from the stations B0, B10, and B20, respectively, as shown in FIG. 3B. It should be understood that the scheduling of wideband transmission slots may be interlaced based on latency requirements and traffic flow associated with some TSN networks.

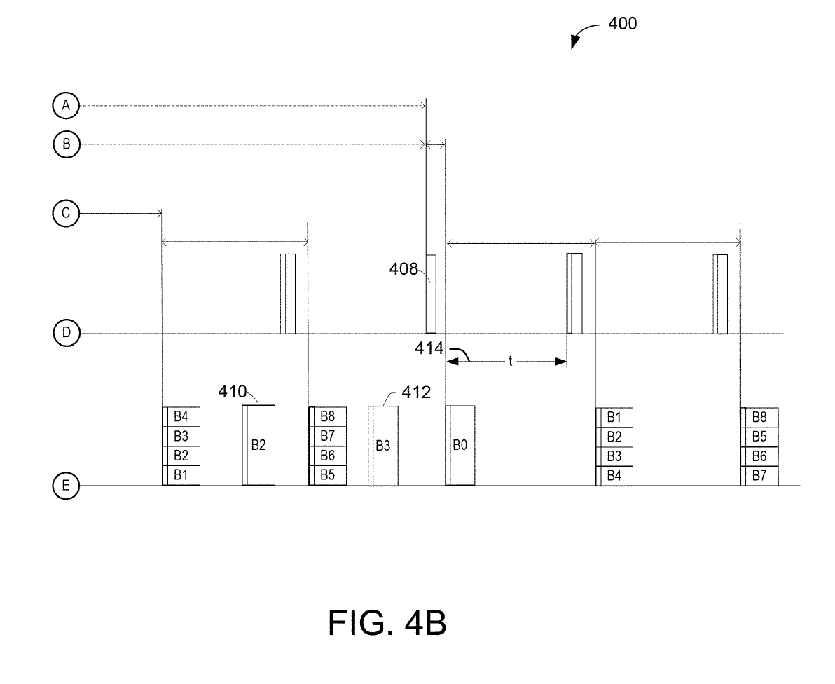

FIGS. 4A-4B depict an illustrative timing diagram of a scheduled data flow 400 for TSN and non-TSN data, in accordance with one or more example embodiments of the present disclosure.

Referring to FIGS. 4A-4B there is shown uplink and downlink data frame flows where a TSN device (e.g., the device 126 of FIG. 1) may receive downlink data frames from an AP (e.g., the AP 102 of FIG. 1) and send uplink data frames to the AP.

In one embodiment, an AP in a WTSN system may be configured to schedule best effort (BE) uplink transmissions (in a wideband transmission window during time interval t 403) after a first beacon frame 401 in frames 404 from non-TSN stations 1-4 in between TSN transmissions in frames 402 and 406 from TSN stations B0 and B1-B4. The non-TSN stations 1-4 may be 802.11ax stations. In one embodiment, the non-TSN stations 1-4 may be configured to understand TSN related protocols. The AP may schedule the transmission of the frames 404 from the non-TSN stations 1-4 while avoiding random contention-based media access by reserving the media persistently (e.g., over a prolonged time period). The media reservation may be done through frequent CTS-to-self transmissions prior to a TSN trigger frame or by setting a Length/Rate in the legacy signal field of a legacy preamble. It should be understood that the aforementioned reservation method may be utilized with both TSN and non-TSN STAs in some embodiments.

In one embodiment, an AP in the WTSN system may modify the OFDMA allocation after each (or several) service period and/or beacon intervals using channel aware scheduling. Channel aware scheduling may include the AP obtaining channel quality information from information from TSN stations. The AP may then use the channel quality information to schedule uplink wideband data transmissions from the TSN stations. For example the AP may schedule a wideband data transmission or a sounding packet transmission for TSN stations in between reserved slots. For example, the transmission of the frames 410 and 412 from the stations B2 and B3, which may be outside persistent scheduling periods, may carry asynchronous data and/or sounding packets. Based on channel information obtained from these transmissions, an AP may assign optimal and dynamic OFDMA allocations to stations B2 and B3 such that the allocation of frames transmitted from stations B1, B2, B3, B4, B5, and B7 (in a wideband transmission window during time interval t 414), may be changed after a second beacon frame 408.

In one embodiment, ACK transmissions (not shown) may be utilized in the WTSN system for scheduled traffic. In the case of immediate ACKs, the WTSN system may ensure that the required time for an AP to transmit downlink frames is provided.

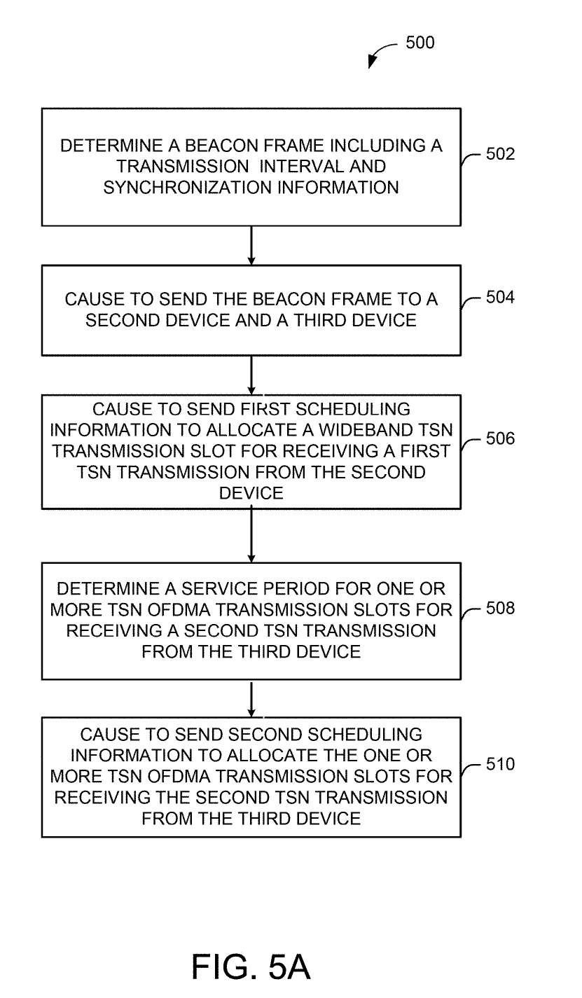

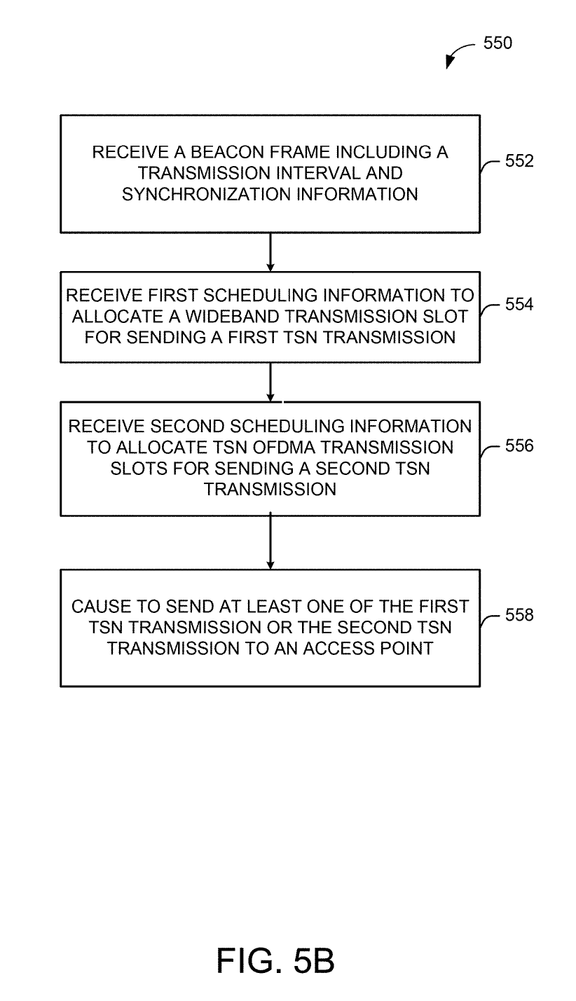

FIG. 5A illustrates a flow diagram of illustrative process 500 for an illustrative persistent scheduling WTSN system, in accordance with one or more example embodiments of the present disclosure.

At block 502, a device (e.g., the user device(s) 120 and/or the AP 102 of FIG. 1) may determine a beacon frame including a transmission interval and synchronization information. For example, an AP may determine a beacon frame from one or more WTSN devices (e.g., a sensor, safety unit, actuator, controller, etc.).

At block 504, the device may cause to send the beacon frame to a second device and a third device. In one embodiment, AP may cause to advertise a TSN trigger frame. The TSN trigger frame may include scheduling information for allocating transmission slots for the first and second devices to communicate with the AP. The scheduling information may be included as an information element in the beacon frame. In one embodiment, the AP may separately (i.e., in addition to the beacon frame) cause to send the TSN trigger frame to the second device and the third device.

At block 506, the device may cause to send first scheduling information, based at least in part on the beacon frame, to allocate a wideband TSN transmission slot for receiving a first TSN transmission from the second device. The first TSN transmission may have a first fixed packet size. For example, the second device may include a station that communicates TSN transmissions using a fixed large packet size. In this embodiment, the device (e.g., the AP) may schedule time staggered wideband transmissions. In one embodiment the AP may schedule interlaced wideband transmissions. The determination of scheduling time staggered or interlaced wideband transmissions may be based on system latency requirements and traffic flow.

At block 508, the device may determine, based at least in part on the beacon frame, a service period for one or more TSN OFDMA transmission slots for receiving a second TSN transmission from the third device. The second TSN transmission may have a second fixed packet size. For example, the third device may include a station that communicates TSN transmissions using a fixed small packet size relative to the second device discussed at block 506. In one embodiment, the device (e.g., an AP) may define a service period T after the beacon frame. The service period may include the duration of the wideband slot scheduled for OFDMA transmission slots.

At block 510, the device may cause to send second scheduling information to allocate the one or more TSN OFDMA transmission slots for receiving the second TSN transmission from the third device based at least in part on the service period. In one embodiment, the device may further be configured to send third scheduling information to allocate one or more non-TSN OFDMA transmission slots for receiving a non-TSN transmission from a fourth device between the first TSN transmission and the second TSN transmission. For example, the device (e.g., an AP) may schedule regular (i.e., non-TSN) best effort uplink transmissions as needed for 802.11ax stations in a network. The 802.11ax stations may include Wi-Fi devices capable of understanding TSN related protocols. The AP may schedule 802.11ax device transmissions while avoiding random contention-based media access by reserving the media persistently. In one embodiment, the media reservation may be accomplished through frequent Clear to Send (CTS)-to-self transmissions prior to the TSN trigger or by setting a Length/Rate in a Legacy Signals field (L-SIG) of a legacy preamble.

In one embodiment, the device may be further configured to cause to send a second beacon frame, including a beacon interval, to the second device and the third device. The device may further be configured to modify the allocation of the one or more TSN OFDMA transmission slots after the beacon interval to enable channel aware scheduling of the second TSN transmission. For example, to take advantage of channel aware scheduling, an AP may modify the OFDMA allocation after each (or several) service periods and/or beacon intervals. This may be accomplished by the AP obtaining channel quality information from other devices (e.g., stations). The AP may schedule wideband data transmission or sounding packet transmission for stations between reserved slots. It is understood that the above descriptions are for purposes of illustration and are not meant to be limiting.

FIG. 5B illustrates a flow diagram of illustrative process 550 for an illustrative persistent scheduling WTSN system, in accordance with one or more example embodiments of the present disclosure.

At block 552, a device (e.g., the user device(s) 120 and/or the AP 102 of FIG. 1) may receive a beacon frame including a transmission interval and synchronization information. For example, a user device may be a WTSN device that may receive a beacon frame from an AP or one or more other WTSN devices (e.g., a sensor, safety unit, actuator, controller, etc.).

At block 554, the device may receive first scheduling information to allocate a wideband TSN transmission slot for sending a first TSN transmission. The first TSN transmission may have a first fixed packet size. For example, the device may include a station that communicates TSN transmissions using a fixed large packet size. In one embodiment, the device may send time staggered or interlaced wideband transmissions. In one embodiment, the device may receive a TSN trigger frame from an AP. The TSN trigger frame may include scheduling information for allocating transmission slots for the device to communicate with the AP. The scheduling information may be included as an information element in the beacon frame. In one embodiment, the TSN trigger frame may be received separately by the device from the AP (i.e., in addition to the beacon frame).

At block 556, the device may receive second scheduling information to allocate the one or more TSN OFDMA transmission slots for sending a second TSN transmission.

At block 558, the device may cause to send the first and/or second TSN transmissions to the AP.

In one embodiment, the device further be configured to receive a modified the allocation of the one or more TSN OFDMA transmission slots (e.g., from the AP) after the beacon interval to enable channel aware scheduling of a second TSN transmission. It is understood that the above descriptions are for purposes of illustration and are not meant to be limiting.

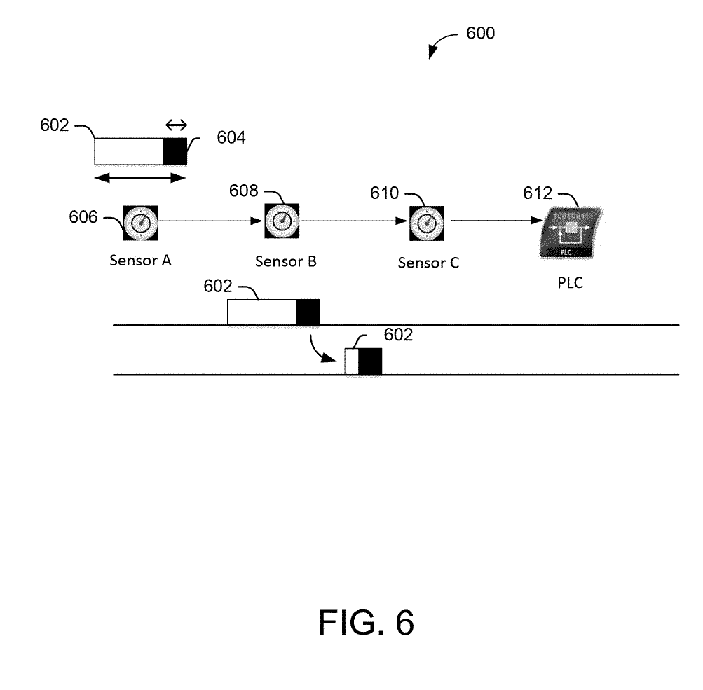

FIG. 6 depicts a diagram illustrating a WTSN system 600 for performing a forwarding while receiving (FWR) data packet flow, in accordance with one or more example embodiments of the present disclosure.

Referring to FIG. 6 there is shown TSN devices 606, 608, 610, and 612 (e.g., the devices 128 and 132 of FIG. 1) communicating data frames from device 606 (e.g., a source device) to device 608 (e.g., a relay device), to device 610 (e.g., a relay device), to device 612 (e.g., a destination device). For example, the devices 606-610 may be sensor devices configured to communicate TSN synchronous data flows to the device 612 which may be a PLC for carrying out one or more operations in an industrial setting. It is understood that the above descriptions are for purposes of illustration and are not meant to be limiting.

In one embodiment, the device (e.g., a sensor B) 608 may be configured to receive a PHY frame 602 from the device 606. The PHY frame 602 may include a PHY source routing preamble 604. The device 608 may be configured to decode the PHY source routing preamble 604 and start forwarding the PHY frame 602 from the device 606 to the device 610 and finally to the device 612. In one embodiment, the device 608 may alternatively be configured to decode part of a MAC sub-frame that identifies the flow from the device 606. It should be understood that the device 606 may be configured to use the device 608 as a relay.

It should be understood that the device 608 may forward the PHY source preamble from the device 606 while still receiving the PHY frame 602. Thus, in the above-described embodiments, may initiate the transmission (e.g., forwarding) of a data frame before the frame is completely received and without involvement of routing layers. Previously, traditional repeaters would only perform forwarding after a data frame is completely received.

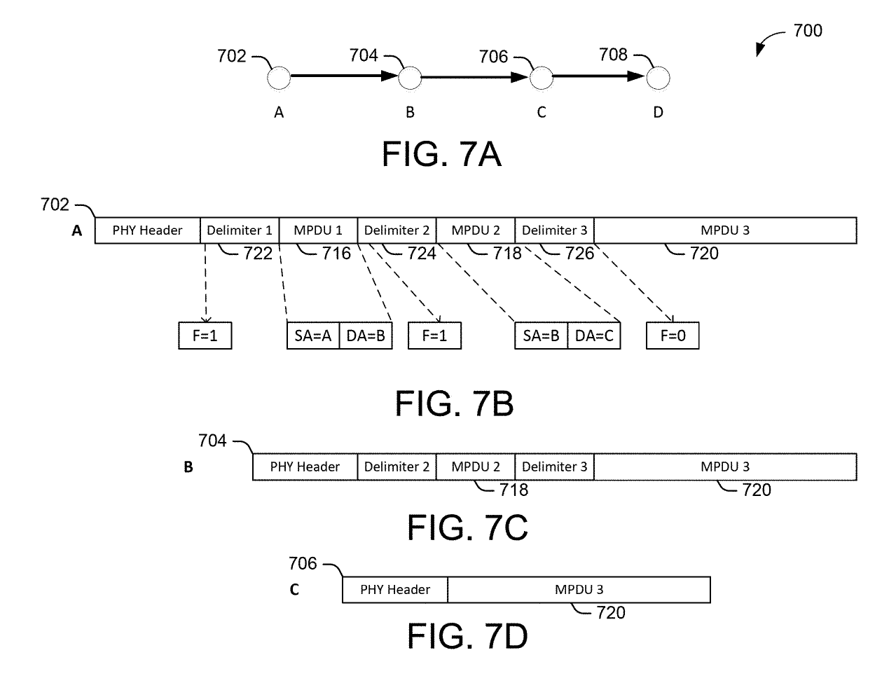

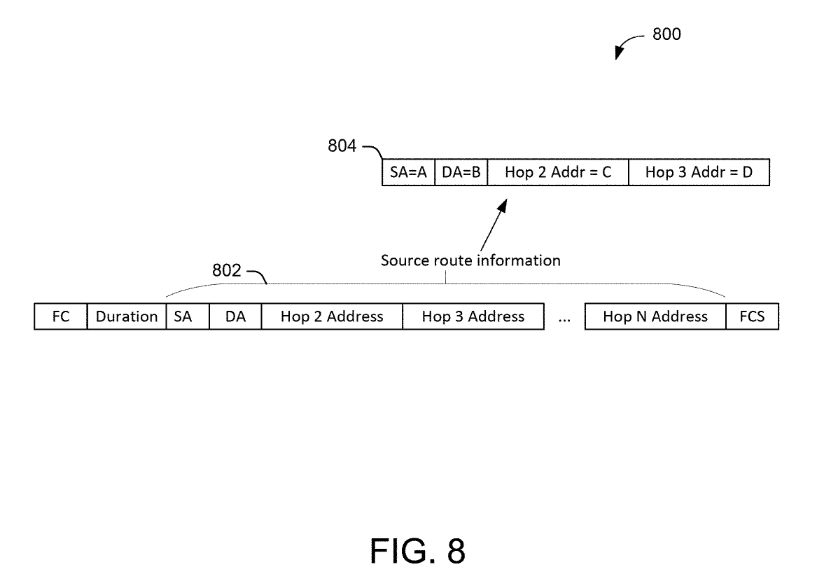

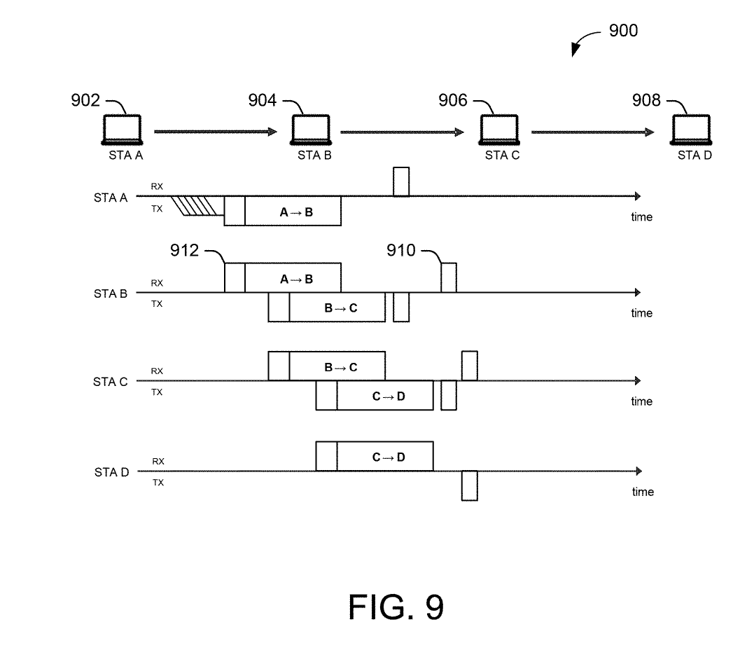

FIGS. 7A-7D depicts a diagram illustrating a WTSN system 700 for performing a forwarding while receiving (FWR) data frame flow, in accordance with one or more example embodiments of the present disclosure.

Referring to FIG. 7 there is shown TSN devices 702, 704, 706, and 708 (e.g., the devices 124-132 of FIG. 1) communicating data frames. One or more of the devices 702-708 may serve as relay nodes for data frames transmitted from a source device (e.g., the device 702) to a destination device (e.g., the device 708). For example, the devices 704 and 706 may be relay devices configured to communicate TSN synchronous data flows from a wireless communication device to a PLC for carrying out one or more operations in an industrial setting. It is understood that the above descriptions are for purposes of illustration and are not meant to be limiting.

In one embodiment, a WTSN system may be configured to add source routing information to enable FWR in separate MPDUs 716, 718, and 720 (which may be transmitted as an A-MPDU. The device 702 (e.g., node A) may be configured to transmit a data frame including source route information for the device 704 (e.g., node B) and the device 706 (e.g., relay node C), to the device 708 (e.g., node D). The device 702 may be configured to transmit a PHY frame (PPDU) 710 which may include A-MPDU sub-frames where MPDUs 716 and 718 carry forwarding information for the device 704 and the device 706. MPDU delimiters 722, 724, and 726 may be configured to signal FWR capability by introducing a fast forwarding bit (F bit). In one embodiment, a reserved bit in an existing MPDU delimiter frame may be used. The MPDUs 716 and 718 (e.g., the intermediate MPDUs) may include a MAC header with the source address (SA) and the destination address (DA) for the next hop. For example, the relay node B 704, while receiving the entire A-MPDU from the device 702, may check the F bit in the MPDU delimiter 722 and DA in the MPDU 716. Since the F bit is set and the MPDU 716 is addressed to the device 704, the device 704 may detect that the remaining A-MPDU sub-frames are to be forwarded. Thus, the device 704 may start forwarding the MPDUs 718 and 720. The device 706 may perform a similar procedure prior to determining to forward the last MPDU (i.e., the MPDU 720) to the final destination at the device 708.

FIG. 8 depicts a diagram illustrating a forwarding while receiving (FWR) data frame flow 800 in an illustrative WTSN system, in accordance with one or more example embodiments of the present disclosure.

In the FWR data frame flow 800, source route information 802 may be included as a control MPDU 804 at the beginning of an A-MPDU. It will be appreciated that this approach may introduce the forwarding information overhead as MAC frames which enables implementation without PHY layer modifications and with only small changes to existing 802.11 MAC layer capabilities.

In one embodiment, a PHY source routing capability may be signaled as part of a common preamble and an identifier (ID) may be added as an optional field in the PHY header when the capability is indicated. Stations that don't implement FWR capability may disregard the additional information and process the data frame as usual (i.e., pass the data frame to the MAC layer) if it is successfully decoded. A station supporting PHY-based forwarding may identify whether the capability is enabled for an incoming packet and determine to use the capability based on the PHY source routing ID in the PHY header. In one embodiment, stations may decode the PHY header in order to start forwarding the packet.

In one embodiment, PHY source routing preambles may be added at the beginning of a forwarded data frame, and relay nodes may be utilized to correctly detect and decode the PHY source routing preambles through the use of additional hardware/software capability added at the relay nodes (or additional radio circuitry, such as a low-power wake-up receiver).

In one embodiment, the routing information and intermediate destination addresses may be included in a signal field of the PHY-Header with separate CRC. Thus, instead of decoding an entire stream of data bits to check the data frame checksum, the PHY layer may start forwarding the packet as soon as it receives and decodes the corresponding signal field.

In one embodiment, the WTSN system may be configured to use upper layer mesh routing protocols (e.g., at the MAC or network layers) to perform routing discovery. Bandwidth reservation along an end-to-end route may also be performed in some embodiments. Once a route (and available bandwidth) is setup for a given data flow, a flow identifier may be generated/assigned to the data flow and distributed/stored by every relay participating in the route. At this point, each relay may also update its routing table (e.g., in the MAC or network layer). In order to use PHY layer forwarding, a relay may store the PHY source routing identifier for each data flow that is allowed to use FWR capability. The PHY source routing preamble for a given data flow may be communicated by the source node and stored by every relay during the route setup process. For example, once a relay confirms it is part of a route (e.g., it adds an entry in its routing/forwarding table), it may store the PHY source routing preamble that identifies the data flow to be forwarded using a cut-through FWR capability.

Once a data frame is received, the relay may check whether the PHY source routing preamble matches the preambles it is expected to forward. If a match is found, the relay may start the process of forwarding the data frame before it is fully received. Otherwise, the data frame may be passed to upper layers, but fast forwarding will not be initiated. It should be understood that not every data flow being routed may be eligible to use a fast forwarding capability. The decision to use the aforementioned capability may be based on various considerations such as higher layer information, a relay node's full-duplex capability, channel condition, latency requirements, a particular implementation, etc. For a PHY-based fast forwarding frame (which has a special PHY preamble for source routing), not every relay node may be capable (or want to) to perform fast forwarding. In such instances, the relay node may not understand (or ignore) the signature PHY preamble and treat a data frame as a normal frame, thus requiring upper layer processing for frame forwarding. For example, in some embodiments, a relay node may intentionally (and/or temporarily) disable FWR capability and behave as a checkpoint for frame correctness.

FIG. 9 depicts a diagram illustrating a WTSN system 900 for performing a forwarding while receiving (FWR) data frame flow, in accordance with one or more example embodiments of the present disclosure.

The WTSN system 900 may include stations 902, 904, 906 and 908. In one embodiment, when FWR is being used with a link layer ACK 910, a relay node (e.g., the station 904) which starts forwarding a data frame 912 while receiving may check whether the data frame 912 is correctly received and transmit the ACK 910 after the forwarding has been completed. In one embodiment, the ACK transmission 910 may follow a delayed ACK (or a delayed block ACK) procedure such that the sender may use a retransmission procedure according to a delayed ACK protocol when FWR capability is used. In the event that the relay node (e.g., the station 904) detects that the data frame 912 was not correctly received while forwarding it to the next hop, it may stop the forwarding immediately and wait for reception of a new frame.

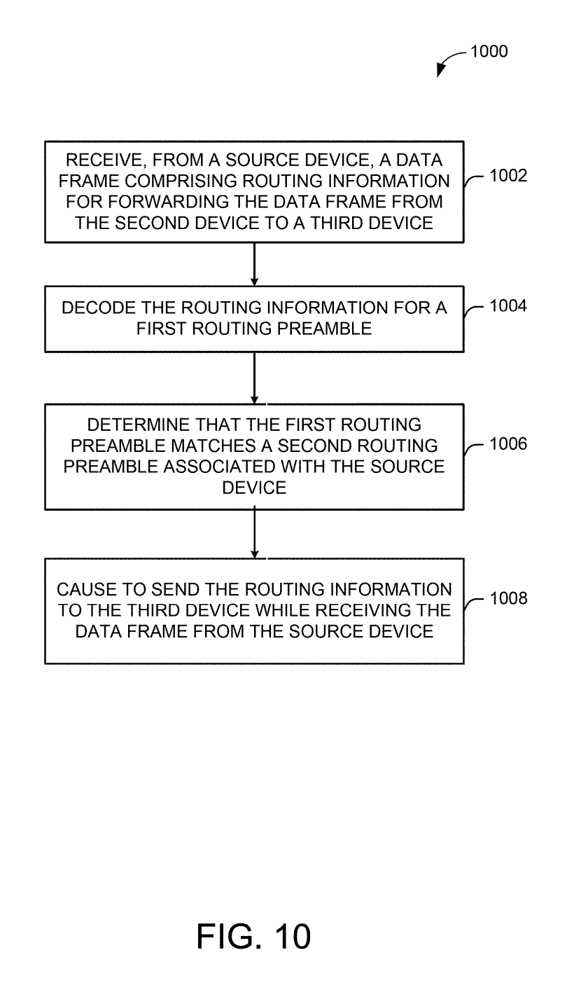

FIG. 10 illustrates a flow diagram of illustrative process 1000 for an illustrative FWR WTSN system, in accordance with one or more example embodiments of the present disclosure.

At block 1002, a device (e.g., the user device(s) 120 and/or the AP 102 of FIG. 1) may receive, from a source device, a data frame comprising routing information for forwarding the data frame from the source device to a third device. For example, a sensor B may serve as a relay for forwarding data frames sent from a sensor A to a PLC. The data frame may be a PHY frame received over a communication channel in accordance with one or more wireless standards, such as TSN or any other communication standard. The routing information may contain one or more sub-frames which may include one or more protocol data units such as a PPDU or a MPDU.

At block 1004, the device may decode the routing information for a first routing preamble. The first routing preamble may include a PHY header or a MAC sub-frame.

At block 1006, the device may determine that the first routing preamble matches a second routing preamble associated with the second device. For example, once a data frame is received, the device (e.g., a relay) may check whether a PHY source routing preamble matches the preambles it is expected to forward. If a match is found, the relay may start the process of forwarding the frame before it is fully received.

At block 1008, the device may cause to send the routing information to the third device while receiving the data frame from the source device. In one embodiment, the device may be configured to initiate a contention procedure on a communication channel adjacent to a communication channel associated with routing information while receiving the data frame or, alternatively, on the same communication channel. For example, when a contention-based MAC protocol is used, the device (e.g., a relay) may start an early contention procedure once it decides to use FWR capability. For example, a relay node can start to contend on an adjacent 20 MHz channel using self-interference cancellation (SIC) capability, while receiving the data frame, so that it can start forwarding the frame as soon as it wins the adjacent channel. In one embodiment, resources may be pre-configured/reserved along the end-to-end-path such that the relay node may start the FWR procedure immediately (i.e., without channel contention).

In one embodiment the device may further verify the receipt of the data frame from the source device, cause to send the data frame to the third device based at least in part on the routing information, and cause to send a delayed acknowledgment to the source device. For example, when FWR is being used with link layer acknowledgments (ACKs), a relay node which starts forwarding a data frame while receiving may check whether the data frame is correctly received and transmit an ACK after the forwarding has been completed. In one embodiment, the ACK transmission may follow a delayed ACK (or a delayed block ACK) procedure such that the sender may use a retransmission procedure according to the delayed ACK protocol when FWR capability is used. In the event that the relay node (e.g., the receiver) detects that the data frame was not correctly received while forwarding it to the next hop, it may stop the forwarding immediately and wait for reception of a new frame. It is understood that the above descriptions are for purposes of illustration and are not meant to be limiting.

FIG. 11 shows a functional diagram of an exemplary communication station 1100 in accordance with some embodiments. In one embodiment, FIG. 11 illustrates a functional block diagram of a communication station that may be suitable for use as an AP 102 (FIG. 1) or a user device 120 (FIG. 1) in accordance with some embodiments. The communication station 1100 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1100 may include communications circuitry 1102 and a transceiver 1110 for transmitting and receiving signals to and from other communication stations using one or more antennas 1101. The communications circuitry 1102 may include circuitry that can operate the physical layer (PHY) communications and/or media access control (MAC) communications for controlling access to the wireless medium, and/or any other communications layers for transmitting and receiving signals. The communication station 1100 may also include processing circuitry 1106 and memory 1108 arranged to perform the operations described herein. In some embodiments, the communications circuitry 1102 and the processing circuitry 1106 may be configured to perform operations detailed in FIGS. 2-10.

In accordance with some embodiments, the communications circuitry 1102 may be arranged to contend for a wireless medium and configure frames or packets for communicating over the wireless medium. The communications circuitry 1102 may be arranged to transmit and receive signals (it should be understood that the signals may be transmitted and received simultaneously in some embodiments). The communications circuitry 1102 may also include circuitry for modulation/demodulation, upconversion/downconversion, filtering, amplification, etc. In some embodiments, the processing circuitry 1106 of the communication station 1100 may include one or more processors. In other embodiments, two or more antennas 1101 may be coupled to the communications circuitry 1102 arranged for sending and receiving signals. The memory 1108 may store information for configuring the processing circuitry 1106 to perform operations for configuring and transmitting message frames and performing the various operations described herein. The memory 1108 may include any type of memory, including non-transitory memory, for storing information in a form readable by a machine (e.g., a computer). For example, the memory 1108 may include a computer-readable storage device, read-only memory (ROM), random-access memory (RAM), magnetic disk storage media, optical storage media, flash-memory devices and other storage devices and media.

In some embodiments, the communication station 1100 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1100 may include one or more antennas 1101. The antennas 1101 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1100 may include one or more of a keyboard, a display, a non-volatile memory port, multiple antennas, a graphics processor, an application processor, speakers, and other mobile device elements. The display may be an LCD screen including a touch screen.

Although the communication station 1100 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1100 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1100 may include one or more processors and may be configured with instructions stored on a computer-readable storage device memory.

FIG. 12 illustrates a block diagram of an example of a machine 1200 or system upon which any one or more of the techniques (e.g., methodologies) discussed herein may be performed. In other embodiments, the machine 1200 may operate as a standalone device or may be connected (e.g., networked) to other machines. In a networked deployment, the machine 1200 may operate in the capacity of a server machine, a client machine, or both in server-client network environments. In an example, the machine 1200 may act as a peer machine in peer-to-peer (P2P) (or other distributed) network environments. The machine 1200 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1200 may include a hardware processor 1202 (e.g., a central processing unit (CPU), a graphics processing unit (GPU), a hardware processor core, or any combination thereof), a main memory 1204 and a static memory 1206, some or all of which may communicate with each other via an interlink (e.g., bus) 1208. The machine 1200 may further include a power management device 1232, a graphics display device 1210, an alphanumeric input device 1212 (e.g., a keyboard), and a user interface (UI) navigation device 1214 (e.g., a mouse). In an example, the graphics display device 1210, alphanumeric input device 1212, and UI navigation device 1214 may be a touch screen display. The machine 1200 may additionally include a storage device (i.e., drive unit) 1216, a signal generation device 1218 (e.g., a speaker), a persistent scheduling WTSN device 1219, a forwarding while receiving (FWR) WSTN device 122, a network interface device/transceiver 1220 coupled to antenna(s) 1230, and one or more sensors 1228, such as a global positioning system (GPS) sensor, a compass, an accelerometer, or other sensor. The machine 1200 may include an output controller 1234, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 1216 may include a machine readable medium 1222 on which is stored one or more sets of data structures or instructions 1224 (e.g., software) embodying or utilized by any one or more of the techniques or functions described herein. The instructions 1224 may also reside, completely or at least partially, within the main memory 1204, within the static memory 1206, or within the hardware processor 1202 during execution thereof by the machine 1200. In an example, one or any combination of the hardware processor 1202, the main memory 1204, the static memory 1206, or the storage device 1216 may constitute machine-readable media.

The persistent scheduling WTSN device 1219 may carry out or perform any of the operations and processes (e.g., processes 500 and 550) described and shown above. For example, the persistent scheduling WTSN device 1219 may be configured to enable synchronous TSN data flows where a TSN station has a fixed packet inter-arrival period and packet size. These data flows may require a minimum and maximum latency with corresponding values being determined by a control loop cycle.

The persistent scheduling WTSN device 1219 may define a protocol for scheduling synchronous data exchange within the existing contention based frame work of the 802.11 WLAN standard specifications.

The persistent scheduling WTSN device 1219 may enable persistent scheduling for the transmission of wireless time sensitive devices in industrial automation scenarios. The persistent scheduling WTSN device 1219 may enable an AP to define frequency multiplexed service periods in which WTSN devices may transmit synchronous short data packets in pre-scheduled time/frequency slots. By enabling the synchronous transmission of short packet sizes with a fixed packet inter-arrival period, minimum and maximum latency requirements for WTSN devices may be met.

It is understood that the above are only a subset of what the persistent scheduling WTSN device 1219 may be configured to perform and that other functions included throughout this disclosure may also be performed by the WTSN device 1219.

The FWR WTSN device 1221 may carry out or perform any of the operations and processes (e.g., processes 1000 and 1050) described and shown above. For example, the FWR WTSN device 1221 may be configured to define protocols to initiate transmission (forwarding) of a data frame before the data frame is completely received and without involvement of routing layers.

The FWR WTSN device 1221 may enable a relay node to identify frames of a data flow using a given multi-hop route that needs to be forwarded and initiate early forwarding (while receiving). The FWR WTSN device 1221 may define a mapping between routes (at the network layer) and forwarding infraction at the PHY/MAC layers per data flow/route and further determine when to use a fast forwarding capability depending on the link. The fast forwarding capability may be used with a reservation-based or a contention-based MAC layer. When used with a contention-based MAC layer, the fast forwarding capability may enable early channel contention at relay nodes, thereby helping to reduce channel access delay.

The FWR WTSN device 1221 may introduce forwarding information in one or more delimiter fields in an aggregate media access protocol data unit (MPDU) transmissions or add a physical layer (PHY) preamble or additional field in a PHY header of a data frame. The aforementioned forwarding information and fast forwarding capability may enable faster source routing capability which may significantly reduce end-to-end latency associated with WTSN devices (especially as the number of hops between source and destination increases).

It is understood that the above are only a subset of what the FWR WTSN device 1221 may be configured to perform and that other functions included throughout this disclosure may also be performed by the FWR WTSN device 1221.

While the machine-readable medium 1222 is illustrated as a single medium, the term “machine-readable medium” may include a single medium or multiple media (e.g., a centralized or distributed database, and/or associated caches and servers) configured to store the one or more instructions 1224.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1200 and that cause the machine 1200 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1224 may further be transmitted or received over a communications network 1226 using a transmission medium via the network interface device/transceiver 1220 utilizing any one of a number of transfer protocols (e.g., frame relay, internet protocol (IP), transmission control protocol (TCP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1220 may include one or more physical jacks (e.g., Ethernet, coaxial, or phone jacks) or one or more antennas to connect to the communications network 1226. In an example, the network interface device/transceiver 1220 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1200 and includes digital or analog communications signals or other intangible media to facilitate communication of such software. The operations and processes (e.g., processes 500 and 1000) described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a single input single output (SISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

According to example embodiments of the disclosure, there may be a device. The device may include memory and processing circuitry configured to determine a beacon frame including a transmission interval and synchronization information for receiving one or more time sensitive network (TSN) transmissions. The memory and processing circuitry may be further configured to cause to send the beacon frame to a first device and a second device. The memory and processing circuitry may be further configured to cause to send first scheduling information, based at least in part on the beacon frame, to allocate a wideband TSN transmission slot for receiving a first TSN transmission in the one or more TSN transmissions from the first device. The first TSN transmission may have a first fixed packet size. The memory and processing circuitry may be further configured to determine, based at least in part on the beacon frame, a service period for one or more TSN Orthogonal Frequency Division Multiple Access (OFDMA) transmission slots for receiving a second TSN transmission in the one or more TSN transmissions from the second device. The second TSN transmission may have a second fixed packet size. The memory and processing circuitry may be further configured to cause to send second scheduling information to allocate the one or more TSN OFDMA transmission slots for receiving the second TSN transmission from the second device based at least in part on the service period.

The implementations may include one or more of the following features. The first and second scheduling information may be in the beacon frame. The memory and processing circuitry may be further configured to cause to send a TSN trigger frame to the first device and the third device. The TSN trigger frame may include the first and second scheduling information. The memory and processing circuitry may be further configured to cause to send third scheduling information to allocate one or more non-TSN OFDMA transmission slots for receiving a non-TSN transmission from a third device between the first TSN transmission and the second TSN transmission. The device may further include a transceiver configured to transmit and receive wireless signals. The device may further include one or more antennas coupled to the transceiver.

According to example embodiments of the disclosure, there may be a device. The device may include memory and processing circuitry configured to receive a beacon frame. The beacon frame may include a transmission interval and synchronization information for receiving one or more time sensitive network (TSN) transmissions. The memory and processing circuitry may be further configured to receive first scheduling information, based at least in part on the beacon frame, to allocate a wideband TSN transmission slot for sending a first TSN transmission. The first TSN transmission may have a first fixed packet size. The memory and processing circuitry may be further configured to receive second scheduling information to allocate one or more TSN Orthogonal Frequency Division Multiple Access (OFDMA) transmission slots for sending a second TSN transmission from the first device based at least in part on the service period. The memory and processing circuitry may be further configured to cause to send the first TSN transmission or the second TSN transmission.

The implementations may include one or more of the following features. The first and second scheduling information may be in the beacon frame. The memory and processing circuitry may be further configured to receive a TSN trigger frame. The TSN trigger frame may include the first and second scheduling information. The memory and processing circuitry may be further configured to receive third scheduling information to allocate one or more non-TSN OFDMA transmission slots for receiving a non-TSN transmission between the first TSN transmission and the second TSN transmission. The memory and processing circuitry may be further configured to receive a second beacon frame including a beacon interval. The memory and processing circuitry may be further configured to receive a modified allocation of the one or more TSN OFDMA transmission slots after the beacon interval to enable channel-aware scheduling of the second TSN transmission. The first TSN transmission may include one of a scheduled staggered wideband transmission or a scheduled interlaced wideband transmission. The device may further include a transceiver configured to transmit and receive wireless signals. The device may further include one or more antennas coupled to the transceiver.

According to example embodiments of the disclosure, there may be a non-transitory computer-readable medium storing computer-executable instructions which, when executed by a processor, cause the processor to perform operations. The operations may include determining a beacon frame including a transmission interval and synchronization information for receiving one or more time sensitive network (TSN) transmissions. The operations may further include causing to send the beacon frame to a first device and a second device. The operations may further include causing to send first scheduling information, based at least in part on the beacon frame, to allocate a wideband TSN transmission slot for receiving a first TSN transmission in the one or more TSN transmissions from the first device. The first TSN transmission may have a first fixed packet size. The operations may further include determining, based at least in part on the beacon frame, a service period for one or more TSN Orthogonal Frequency Division Multiple Access (OFDMA) transmission slots for receiving a second TSN transmission in the one or more TSN transmissions from the second device. The second TSN transmission may have a second fixed packet size. The operations may further include causing to send second scheduling information to allocate the one or more TSN OFDMA transmission slots for receiving the second TSN transmission from the second device based at least in part on the service period.

The implementations may include one or more of the following features. The first and second scheduling information may be in the beacon frame. The operations may further include causing to send a TSN trigger frame to the first device and the second device. The TSN trigger frame may include the first and second scheduling information. The operations may further include causing to send third scheduling information to allocate one or more non-TSN OFDMA transmission slots for receiving a non-TSN transmission from a third device between the first TSN transmission and the second TSN transmission. The operations may further include causing to send a second beacon frame to the first device and the second device. The second beacon frame may include a beacon interval. The operations may further include modifying the allocation of the one or more TSN OFDMA transmission slots after the beacon interval to enable channel-aware scheduling of the second TSN transmission. The first TSN transmission may include one of a scheduled staggered wideband transmission or a scheduled interlaced wideband transmission.

According to example embodiments of the disclosure, there may be a non-transitory computer-readable medium storing computer-executable instructions which, when executed by a processor, cause the processor to perform operations. The operations may include receiving a beacon frame. The beacon frame may include a transmission interval and synchronization information for receiving one or more time sensitive network (TSN) transmissions. The operations may further include receiving first scheduling information, based at least in part on the beacon frame, to allocate a wideband TSN transmission slot for sending a first TSN transmission. The first TSN transmission may have a first fixed packet size. The operations may further include receiving second scheduling information to allocate one or more TSN Orthogonal Frequency Division Multiple Access (OFDMA) transmission slots for sending a second TSN transmission from the first device based at least in part on the service period. The operations may further include causing to send at least one of the first TSN transmission or the second TSN transmission.

The implementations may include one or more of the following features. The first and second scheduling information may be in the beacon frame. The operations may further include receiving a TSN trigger frame. The TSN trigger frame may include the first and second scheduling information. The operations may further include receiving third scheduling information to allocate one or more non-TSN OFDMA transmission slots for receiving a non-TSN transmission between the first TSN transmission or the second TSN transmission. The operations may further include receiving a second beacon frame including a beacon interval. The operations may further include receiving a modified allocation of the one or more TSN OFDMA transmission slots after the beacon interval to enable channel-aware scheduling of the second TSN transmission. The first TSN transmission may include one of a scheduled staggered wideband transmission or a scheduled interlaced wideband transmission.

According to example embodiments of the disclosure, there may include a method. The method may include determining, by one or more processors, a beacon frame including a transmission interval and synchronization information for receiving one or more time sensitive network (TSN) transmissions. The method may further include causing to send the beacon frame to a first device and a second device. The method may further include causing to send first scheduling information, based at least in part on the beacon frame, to allocate a wideband TSN transmission slot for receiving a first TSN transmission in the one or more TSN transmissions from the first device. The first TSN transmission may have a first fixed packet size. The method may further include determining, based at least in part on the beacon frame, a service period for one or more TSN Orthogonal Frequency Division Multiple Access (OFDMA) transmission slots for receiving a second TSN transmission in the one or more TSN transmissions from the second device. The second TSN transmission may have a second fixed packet size. The method may further include causing to send second scheduling information to allocate the one or more TSN OFDMA transmission slots for receiving the second TSN transmission from the second device based at least in part on the service period.

The implementations may include one or more of the following features. The first and second scheduling information may be in the beacon frame. The method may further include causing to send a TSN trigger frame to the first device and the second device. The TSN trigger frame may include the first and second scheduling information. The method may further include causing to send third scheduling information to allocate one or more non-TSN OFDMA transmission slots for receiving a non-TSN transmission from a third device between the first TSN transmission and the second TSN transmission. The method may further include causing to send a second beacon frame to the first device and the second device. The second beacon frame may include a beacon interval. The method may further include modifying the allocation of the one or more TSN OFDMA transmission slots after the beacon interval to enable channel-aware scheduling of the second TSN transmission. The first TSN transmission may include one of a scheduled staggered wideband transmission or a scheduled interlaced wideband transmission.

According to example embodiments of the disclosure, there may be a method. The method may include receiving a beacon frame. The beacon frame may include a transmission interval and synchronization information for receiving one or more time sensitive network (TSN) transmissions. The method may further include receiving first scheduling information, based at least in part on the beacon frame, to allocate a wideband TSN transmission slot for sending a first TSN transmission. The first TSN transmission may have a first fixed packet size. The method may further include receiving second scheduling information to allocate one or more TSN Orthogonal Frequency Division Multiple Access (OFDMA) transmission slots for sending a second TSN transmission from the first device based at least in part on the service period. The method may further include causing to send at least one of the first TSN transmission or the second TSN transmission.

The implementations may include one or more of the following features. The first and second scheduling information may be in the beacon frame. The method may further include receiving a TSN trigger frame. The TSN trigger frame may include the first and second scheduling information. The method may further include receiving third scheduling information to allocate one or more non-TSN OFDMA transmission slots for receiving a non-TSN transmission between the first TSN transmission or the second TSN transmission. The method may further include receiving a second beacon frame including a beacon interval. The method may further include receiving a modified allocation of the one or more TSN OFDMA transmission slots after the beacon interval to enable channel-aware scheduling of the second TSN transmission. The first TSN transmission may include one of a scheduled staggered wideband transmission or a scheduled interlaced wideband transmission.

In example embodiments of the disclosure, there may be an apparatus. The apparatus may include means for determining a beacon frame including a transmission interval and synchronization information for receiving one or more time sensitive network (TSN) transmissions. The apparatus may further include means for causing to send the beacon frame to a first device and a second device. The apparatus may further include means for causing to send first scheduling information, based at least in part on the beacon frame, to allocate a wideband TSN transmission slot for receiving a first TSN transmission in the one or more TSN transmissions from the first device. The first TSN transmission may have a first fixed packet size. The apparatus may further include means for determining, based at least in part on the beacon frame, a service period for one or more TSN Orthogonal Frequency Division Multiple Access (OFDMA) transmission slots for receiving a second TSN transmission in the one or more TSN transmissions from the second device. The second TSN transmission may have a second fixed packet size. The apparatus may further include means for causing to send second scheduling information to allocate the one or more TSN OFDMA transmission slots for receiving the second TSN transmission from the second device based at least in part on the service period.

The implementations may include one or more of the following features. The first and second scheduling information may be in the beacon frame. The apparatus may further include means for causing to send a TSN trigger frame to the first device and the second device. The TSN trigger frame may include the first and second scheduling information. The apparatus may further include means for causing to send third scheduling information to allocate one or more non-TSN OFDMA transmission slots for receiving a non-TSN transmission from a third device between the first TSN transmission and the second TSN transmission. The apparatus may further include means for causing to send a second beacon frame to the first device and the second device. The second beacon frame may include a beacon interval. The apparatus may further include means for modifying the allocation of the one or more TSN OFDMA transmission slots after the beacon interval to enable channel-aware scheduling of the second TSN transmission. The first TSN transmission may include one of a scheduled staggered wideband transmission or a scheduled interlaced wideband transmission.

According to example embodiments of the disclosure, there may be an apparatus. The apparatus may include means for receiving a beacon frame. The beacon frame may include a transmission interval and synchronization information for receiving one or more time sensitive network (TSN) transmissions. The apparatus may further include means for receiving first scheduling information, based at least in part on the beacon frame, to allocate a wideband TSN transmission slot for sending a first TSN transmission. The first TSN transmission may have a first fixed packet size. The apparatus may further include means for receiving second scheduling information to allocate one or more TSN Orthogonal Frequency Division Multiple Access (OFDMA) transmission slots for sending a second TSN transmission from the first device based at least in part on the service period. The apparatus may further include means for causing to send at least one of the first TSN transmission or the second TSN transmission.

The implementations may include one or more of the following features. The first and second scheduling information may be in the beacon frame. The apparatus may further include means for receiving a TSN trigger frame. The TSN trigger frame may include the first and second scheduling information. The apparatus may further include means for receiving third scheduling information to allocate one or more non-TSN OFDMA transmission slots for receiving a non-TSN transmission between the first TSN transmission or the second TSN transmission. The apparatus may further include means for receiving a second beacon frame including a beacon interval. The apparatus may further include means for receiving a modified allocation of the one or more TSN OFDMA transmission slots after the beacon interval to enable channel-aware scheduling of the second TSN transmission. The first TSN transmission may include one of a scheduled staggered wideband transmission or a scheduled interlaced wideband transmission.

According to example embodiments of the disclosure, there may be a device. The device may include memory and processing circuitry configured to receive, from a first device, a data frame comprising routing information for forwarding the data frame from the first device to a third device. The memory and processing circuitry may be further configured to decode the routing information. The memory and processing circuitry may be further configured to determine that a first routing preamble matches a second routing preamble associated with the first device. The memory and processing circuitry may be further configured to cause to send the routing information to the second device while receiving the data frame from the first device.

The implementations may include one or more of the following features. The routing information may include one or more sub-frames. The one or more sub-frames may include one or more protocol data units. The first routing preamble may include a PHY header or a media access control (MAC) sub-frame. The memory and the processing circuitry may be further configured to initiate a contention procedure on a communication channel adjacent to a communication channel associated with the routing information while receiving the data frame. The memory and the processing circuitry may be further configured to verify receipt of the data frame from the first device, cause to send the data frame to the second device based at least in part on the routing information, and cause to send a delayed acknowledgment to the first device. The device may further include a transceiver configured to transmit and receive wireless signals. The device may further include one or more antennas coupled to the transceiver.

According to example embodiments of the disclosure, there may be a non-transitory computer-readable medium storing computer-executable instructions which, when executed by a processor, cause the processor to perform operations. The operations may include receiving, from a first device, a data frame comprising routing information for forwarding the data frame from the first device to a third device. The operations may further include decoding the routing information. The operations may further include determining that a first routing preamble matches a second routing preamble associated with the first device. The operations may further include causing to send the routing information to the second device while receiving the data frame from the first device.

The implementations may include one or more of the following features. The routing information may include one or more sub-frames. The one or more sub-frames may include one or more protocol data units. The first routing preamble may include a PHY header or a media access control (MAC) sub-frame. The operations may further include initiating a contention procedure on a communication channel adjacent to a communication channel associated with the routing information while receiving the data frame. The operations may further include verifying receipt of the data frame from the first device, causing to send the data frame to the second device based at least in part on the routing information, and causing to send a delayed acknowledgment to the first device.

According to example embodiments of the disclosure, there may be a method. The method may include receiving, from a first device, a data frame comprising routing information for forwarding the data frame from the first device to a third device. The method may further include decoding the routing information. The method may further include determining that a first routing preamble matches a second routing preamble associated with the first device. The method may further include causing to send the routing information to the second device while receiving the data frame from the first device.

The implementations may include one or more of the following features. The routing information may include one or more sub-frames. The one or more sub-frames may include one or more protocol data units. The first routing preamble may include a PHY header or a media access control (MAC) sub-frame. The method may further include initiating a contention procedure on a communication channel adjacent to a communication channel associated with the routing information while receiving the data frame. The method may further include verifying receipt of the data frame from the first device, causing to send the data frame to the second device based at least in part on the routing information, and causing to send a delayed acknowledgment to the first device.

In example embodiments of the disclosure, there may be an apparatus. The apparatus may include means for receiving, from a first device, a data frame comprising routing information for forwarding the data frame from the first device to a third device. The apparatus may further include means for decoding the routing information. The apparatus may further include means for determining that a first routing preamble matches a second routing preamble associated with the first device. The apparatus may further include means for causing to send the routing information to the second device while receiving the data frame from the first device.

The implementations may include one or more of the following features. The routing information may include one or more sub-frames. The one or more sub-frames may include one or more protocol data units. The first routing preamble may include a PHY header or a media access control (MAC) sub-frame. The apparatus may further include means for initiating a contention procedure on a communication channel adjacent to a communication channel associated with the routing information while receiving the data frame. The apparatus may further include means for verifying receipt of the data frame from the first device, causing to send the data frame to the second device based at least in part on the routing information, and causing to send a delayed acknowledgment to the first device.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising memory and processing circuitry, configured to:
determine a beacon frame including a transmission interval and synchronization information for receiving one or more time sensitive network (TSN) transmissions;
cause to send the beacon frame to a first device and a second device;
cause to send first scheduling information, based at least in part on the beacon frame, to allocate a wideband TSN transmission slot for receiving a first TSN transmission in the one or more TSN transmissions from the first device, the first TSN transmission comprising a first fixed packet size;
determine, based at least in part on the beacon frame, a service period for one or more TSN Orthogonal Frequency Division Multiple Access (OFDMA) transmission slots for receiving a second TSN transmission in the one or more TSN transmissions from the second device, the second TSN transmission comprising a second fixed packet size; and
cause to send second scheduling information to allocate the one or more TSN OFDMA transmission slots for receiving the second TSN transmission from the second device based at least in part on the service period.

2. The device of claim 1, wherein the first and second scheduling information are in the beacon frame.

3. The device of claim 1, wherein the memory and the processing circuitry is further configured to cause to send a TSN trigger frame to the first device and the third device, wherein the TSN trigger frame comprises the first and second scheduling information.

4. The device of claim 1, wherein the memory and the processing circuitry is further configured to cause to send third scheduling information to allocate one or more non-TSN OFDMA transmission slots for receiving a non-TSN transmission from a third device between the first TSN transmission and the second TSN transmission.

5. The device of claim 1, wherein the memory and the processing circuitry is further configured to:
cause to send a second beacon frame to the first device and the second device, the second beacon frame comprising a beacon interval; and
modify the allocation of the one or more TSN OFDMA transmission slots after the beacon interval to enable channel-aware scheduling of the second TSN transmission.

6. The device of claim 1, wherein the first TSN transmission comprises one of a scheduled staggered wideband transmission or a scheduled interlaced wideband transmission.

7. The device of claim 1, further comprising a transceiver configured to transmit and receive wireless signals.

8. The device of claim 8, further comprising one or more antennas coupled to the transceiver.

9. A non-transitory computer-readable medium storing computer-executable instructions which when executed by one or more processors result in performing operations comprising:
receiving a beacon frame, the beacon frame including a transmission interval and synchronization information for receiving one or more time sensitive network (TSN) transmissions;
receiving first scheduling information, based at least in part on the beacon frame, to allocate a wideband TSN transmission slot for sending a first TSN transmission, the first TSN transmission comprising a first fixed packet size;
receiving second scheduling information to allocate one or more TSN Orthogonal Frequency Division Multiple Access (OFDMA) transmission slots for sending a second TSN transmission from t device first device based at least in part on the service period; and
causing to send at least one of the first TSN transmission or the second TSN transmission.

10. The non-transitory computer-readable medium of claim 9, wherein the first and second scheduling information are in the beacon frame.

11. The non-transitory computer-readable medium of claim 9, further comprising receiving a TSN trigger frame, wherein the TSN trigger frame comprises the first and second scheduling information.

12. The non-transitory computer-readable medium of claim 9, further comprising receiving third scheduling information to allocate one or more non-TSN OFDMA transmission slots for receiving a non-TSN transmission between the first TSN transmission and the second TSN transmission.

13. The non-transitory computer-readable medium of claim 9, further comprising:
receiving a second beacon frame comprising a beacon interval; and
receiving a modified allocation of the one or more TSN OFDMA transmission slots after the beacon interval to enable channel-aware scheduling of the second TSN transmission.

14. The non-transitory computer-readable medium of claim 9, wherein the first TSN transmission comprises one of a scheduled staggered wideband transmission or a scheduled interlaced wideband transmission.

15. A method comprising:
determining, by one or more processors, a beacon frame including a transmission interval and synchronization information for receiving one or more time sensitive network (TSN) transmissions;
causing to send the beacon frame to a first device and a second device;
causing to send first scheduling information, based at least in part on the beacon frame, to allocate a wideband TSN transmission slot for receiving a first TSN transmission in the one or more TSN transmissions from the first device, the first TSN transmission comprising a first fixed packet size;
determining, based at least in part on the beacon frame, a service period for one or more TSN Orthogonal Frequency Division Multiple Access (OFDMA) transmission slots for receiving a second TSN transmission in the one or more TSN transmissions from the second device, the second TSN transmission comprising a second fixed packet size; and
causing to send second scheduling information to allocate the one or more TSN OFDMA transmission slots for receiving the second TSN transmission from the second device based at least in part on the service period.

16. The method of claim 15, wherein the first and second scheduling information are in the beacon frame.

17. The method of claim 15, further comprising causing to send a TSN trigger frame to the first device and the second device, wherein the TSN trigger frame comprises the first and second scheduling information.

18. The method of claim 15, further comprising causing to send third scheduling information to allocate one or more non-TSN OFDMA transmission slots for receiving a non-TSN transmission from a third device between the first TSN transmission and the second TSN transmission.

19. The method of claim 15, further comprising:
causing to send a second beacon frame to the first device and the second device, the second beacon frame comprising a beacon interval; and
modifying the allocation of the one or more TSN OFDMA transmission slots after the beacon interval to enable channel-aware scheduling of the second TSN transmission.

20. The method of claim 15, wherein the first TSN transmission comprises one of a scheduled staggered wideband transmission or a scheduled interlaced wideband transmission.

21. A device, the device comprising memory and processing circuitry, configured to:
receive, from a first device, a data frame comprising routing information for forwarding the data frame from the first device to a third device;
decode the routing information;
determine that a first routing preamble matches a second routing preamble associated with the first device; and
cause to send the routing information to the second device while receiving the data frame from the first device.

22. The device of claim 21, wherein the routing information comprises one or more sub-frames.

23. The device of claim 22, wherein the one or more sub-frames comprise one or more protocol data units.

24. The device of claim 21, wherein the first routing preamble comprises a PHY header or a media access control (MAC) sub-frame.

25. The device of claim 21, wherein the memory and the processing circuitry is further configured to initiate a contention procedure on a communication channel adjacent to a communication channel associated with the routing information while receiving the data frame.

26. The device of claim 21, wherein the memory and the processing circuitry is further configured to:
verify receipt of the data frame from the first device;
cause to send the data frame to the second device based at least in part on the routing information; and
cause to send a delayed acknowledgment to the first device.

27. The device of claim 21, further comprising a transceiver configured to transmit and receive wireless signals.

28. The device of claim 27, further comprising one or more antennas coupled to the transceiver.

29. A non-transitory computer-readable medium storing computer-executable instructions which when executed by one or more processors result in performing operations comprising:
receiving, from a first device, a data frame comprising routing information for forwarding the data frame from the first device to a second device;
decoding the routing information;
determining that the first routing preamble matches a second routing preamble associated with the first device; and
causing to send the routing information to the third device while receiving the data frame from the first device.

30. The non-transitory computer-readable medium of claim 29, wherein the routing information comprises one or more sub-frames.

31. The non-transitory computer-readable medium of claim 30, wherein the one or more sub-frames comprise one or more protocol data units.

32. The non-transitory computer-readable medium of claim 29, wherein the first routing preamble comprises a PHY header or a media access control (MAC) sub-frame.

33. The non-transitory computer-readable medium of claim 29, further comprising initiating a contention procedure on a communication channel adjacent to a communication channel associated with the routing information while receiving the data frame.

34. The non-transitory computer-readable medium of claim 29, further comprising:
verifying receipt of the data frame from the second device;
causing to send the data frame to the third device based at least in part on the routing information; and
causing to send a delayed acknowledgment to the second device.

35. A method comprising:
receiving, from a first device, a data frame comprising routing information for forwarding the data frame from the first device to a second device;
decoding the routing information;
determining that the first routing preamble matches a second routing preamble associated with the first device; and
causing to send the routing information to the third device while receiving the data frame from the first device.

36. The method of claim 35, wherein the routing information comprises one or more sub-frames.

37. The method of claim 36, wherein the one or more sub-frames comprise one or more protocol data units.

38. The method of claim 35, wherein the first routing preamble comprises a PHY header or a media access control (MAC) sub-frame.

39. The method of claim 35, further comprising initiating a contention procedure on a communication channel adjacent to a communication channel associated with the routing information while receiving the data frame.

40. The method of claim 35, further comprising:
verifying receipt of the data frame from the second device;
causing to send the data frame to the third device based at least in part on the routing information; and
causing to send a delayed acknowledgment to the second device.
